(19) United States
(12) Patent Application Publication
(10) Pub. No.: US 2007/0057622 A1
(43) Pub. Date: Mar. 15, 2007

(54) Display device

(76) Inventors: Shigemi Hirasawa, Chiba (JP); Akira Hatori, Chiba (JP); Yuichi Inoue, Mobara (JP); Hiroshi Ito, Chiba (JP); Nobuhiko Fukuoka, Ebina (JP)

Correspondence Address: REED SMITH LLP, Suite 1400, 3110 Fairview Park Drive, Falls Church, VA, 22042, US

(21) Appl. No.: 11/516,743

(22) Filed: Sep. 7, 2006

(30) Foreign Application Priority Data
Sep. 9, 2005 (JP) 2005-261957

(51) Int. Cl. H01J 63/04; H01J 1/62

(52) U.S. Cl. 313/496

(57) ABSTRACT

Spacers are fixed on scanning signal lines by a bonding member and conductive bonding member. Since the scanning signal lines and the spacers formed on a back substrate are fixed with the bonding member and the conductive bonding member, electrostatic charge of the spacers can be prevented. According to the invention, a display device which can obtain an image display with a high white uniformity is provided by stabilizing the potential applied to spacers and stabilizing the beam landing of electron beams.

### BACKGROUND OF THE INVENTION

1. Field of the Invention

The present invention relates to a flat panel display device utilizing electron emission to vacuum formed between a front substrate and a back substrate and, more specifically, to a display device provided with a plurality of spacer members between the front substrate and the back substrate.

2. Description of the Related Art

Hitherto, a color cathode tube is widely used as a display device which is superior in terms of high luminance and high fineness. However, in association with extended definition of information processing device or TV broadcasting in recent years, a light-weight, space-saving flat panel display (FPD) device having a high-luminance and high-fineness characteristics is highly demanded.

As a typical example, a liquid crystal display device and a plasma display device are in practical use. In particular, various types of flat panel display device such as so-called an electron emission display device or a field emission display device as a self luminous display device utilizing electron emission from electron sources to vacuum, or an organic EL display device characterized by low power consumption are now in practical use.

In the self luminance flat panel display device out of various flat panel display devices, a configuration in which the electron sources are arranged in a matrix pattern is known, and as an example, the aforementioned field emission display device (FED) in which a minute and integratable cold cathode is used is also known. The self luminance display device can achieve high luminance configuration.

In the electron emission display device, electron sources of various types such as a Spindt type, a surface conduction type, carbon nano tube type, or a thin film type such as MIM (Metal-Insulator-Metal) type in which metal-insulator-metal are laminated, MIS (Metal-Insulator-Semiconductor) type in which metal-insulator-semiconductors are laminated, or a metal-insulator-semiconductor-metal type are used for the cold cathode.

The MIM type electron sources, for example, disclosed in JP-A-7-65710 and JP-A-10-153979 are known. A MOS type is known as the Metal-Insulator-Semiconductor type electron source, and a HEED type electron source, an EL-type electron source, and a porous silicon type electron source are known as the Metal-Insulator-Semiconductor-Metal type electron source.

The electron emission FPD includes the back substrate provided with the electron sources as described above and the front substrate provided with fluorescent material layers and anodes which constitutes an accelerator voltage for causing electrons emitted from the electron sources to collide with each other on the fluorescent material layers so as to oppose to each other. The electron emission FPD includes a space surrounded by a front substrate, a back substrate and a frame sealed in a predetermined vacuum state. A drive circuit is combined to this display panel to bring into operation.

In the display device having the MIM type electron sources, the back substrate is formed of insulating material. The substrate is formed thereon with a plurality of scanning signal lines extending in one direction and arranged in parallel in the other direction orthogonal to the one direction for applying scanning signals in sequence in the other direction. A plurality of image signal lines extending in the other direction and arranged in parallel in the one direction so as to intersect the scanning signal lines are formed on this substrate. The above-described electron sources are provided by being connected to the scanning signal lines and the image signal lines. The both lines and the electron sources are connected by power feed electrodes so that a current is supplied to the electron sources.

The respective electron sources constitute unit pixels in pairs with the corresponding fluorescent material layers. Generally, the unit pixels in three colors; red (R), green (G) and blue (B) constitute one pixel (color pixel). In the case of the color pixel, the unit pixel which constitutes each color is also referred to as a sub pixel.

Generally in the flat panel display device configured as described above, the plurality of spacer members (hereinafter referred to as spacer) are arranged and fixed in a space surrounded by the frame between the back substrate and the front substrate to keep the distance between the both substrates at a predetermined distance in cooperation with the frame. The spacers are generally plate-shaped members formed of an insulating material such as glass or ceramics and are arranged normally at positions which do not impair the operation of the respective plurality of pixels.

In Japanese Patent No. 3303166, a flat panel display device having a display panel of a configuration in which semiconductive spacers are connected to electrodes in contact thereto is proposed. In U.S. Pat. No. 6,225,737, a flat panel display device of a configuration in which a conductive film which dissolves a conductive material is formed from the side surface to the bottom surface of a wall member is proposed.

In the related art, the FPD of a configuration having the frame for keeping the distance between the both substrates and the plurality of spacers arranged in the area surrounded by the frame is proposed. The spaces are arranged in the display area, for example, in parallel with the scanning signal lines. Electrons emitted from the electron sources are accelerated by application of anode voltage and collide against the fluorescent material layers to cause the fluorescent materials to emit light. Part of electrons emitted from the electron sources electrifies the spacers. When the spacers are electrified, there arises a problem such that trajectories of the electrons emitted from the electron sources are distorted, and hence sufficient electrons cannot be brought into collision with the fluorescent material layer, thereby resulting in insufficient excitation. Consequently, insufficient luminance or deterioration of color reproducibility comes into an issue. An electrostatic charge of the spacer results in deterioration of voltage proof characteristics between the both substrates, which may be a problem that elongation of lifetime is hindered.

In addition, in the display device of this type, since the distance between the both substrates is set to a small distance on the order of several millimeters, discharge of gas of a bonding member for fixing the space is liable to be insufficient. This is one of causes which make maintenance of high vacuum in difficult, and may be a hindrance to increase in lifetime. As one of countermeasures for problems caused by the electrostatic charge of the spacers, Japanese Patent No. 3303166 discloses a configuration to provide semi conductivity to the surfaces of the spacers and the semi-conductive films are electrically connected to conductive films provided on the top surfaces and the bottom surfaces of the spacers. However, since the conductive films on the bottom surfaces are exposed in the vacuum area, and hence the conductive films may act as electrodes in a state of being faced to anodes. Therefore, there remain various problems such as restraint of electron emission or distortion of trajectory of electron, and hence further improvement is required.

### SUMMARY OF THE INVENTION

In order to solve the above-described problems in the related art, it is an object of the invention to provide a display device which provides an image display with a high white uniformity, by stabilizing the potential applied to spacers and stabilizing the beam landing of electron beams.

In order to achieve the object as described above, according to a display device in the invention, the conductive bonding members are interposed at proximal portions of spacer members (spacers) fixedly arranged on the back substrate via bonding members. Consequently, contact between spacers and conductive bonding member is ensured, and hence the problems in the related art can be solved.

According to the invention, since the conductive bonding members are interposed between the spacers and the bonding members, reliable electric contact between the spacers and the conductive bonding members is ensured. Therefore, discharge during operation can be prevented in advance. Since the potential applied to the spacer member is stabilized, the beam landing of the electron beams is stabilized, and hence distortion of an image in the vicinity of the spacers is avoided. Therefore, since a display image with high white uniformity can be obtained, the invention has a superior advantage such that a display device of high-quality and high-reliability can be obtained.

Since the thin film electron sources are provided, the invention has extremely effective advantages such that a superior beam converging capability is provided, surface contamination of the electron sources can be avoided, thereby achieving good electron emitting characteristics, and a long life and highly reliable display device can be provided.

Since the spacers are superimposed on the scanning signal lines and arranged and extended in the same direction as the scanning signal lines, the invention has an extremely effective advantage such that electrode-related members such as the electron sources and the image signal lines can be prevented from becoming damaged.

Since the spacers are coated with the conductive bonding members on the sides of the back substrate, the invention has an extremely superior advantage such that the electrostatic charge of the spacers is prevented and hence a display device superior in voltage proof characteristics is provided.

Since the value of resistance of the conductive bonding member is set to be lower than that of the bonding member, the invention has an extremely superior advantage such that the electrostatic charge of the spacers is prevented and hence a display device superior in voltage proof characteristics is provided.

Since the ratio of the vitrifiable component in the bonding member is at least 30 wt %, and the ratio of the conductive component in the conductive bonding member is at least 30 wt %, importance of the structure is given to adhesiveness in the spacers and to conductivity in the conductive bonding member, and hence the invention has an extremely superior advantage such that reliability of bonding fixation and electrical connection of the spacers with respect to the front substrate and the back substrate is ensured.

The invention is not limited to the above-described configuration, and to the configuration in examples shown below, and hence various modifications may be made without departing from the scope of the invention.

### BRIEF DESCRIPTION OF THE DRAWINGS

FIG. 1 is a plan view viewed from the side of a front substrate for explaining an embodiment of the display device according to the invention;

FIG. 2 is a side view viewed from a direction I in FIG. 1;

FIG. 3 is a pattern plan view of a back substrate shown with the front substrate in FIG. 1 removed;

FIG. 4 is an enlarged pattern cross-sectional view of the back substrate and the front substrate corresponding thereto taken along the line II-II in FIG. 3;

FIG. 5 is an enlarged pattern cross-sectional view of a principal portion taken along the line III-III in FIG. 3;

FIG. 6 is a plan view showing an example of the spacer arrangement pattern of the display device according to the invention;

FIG. 7 is a plan view of a principal portion of the back substrate which constitutes the display device according to the invention;

FIG. 8 is a plan view of a principal portion of the front substrate which constitutes the display device according to the invention; and

FIG. 9 is an enlarged cross-sectional view of a principal portion of a fluorescent surface formed on the front substrate of the display device according to the invention.

### DESCRIPTION OF THE PREFERRED EMBODIMENTS

### EXAMPLE 1

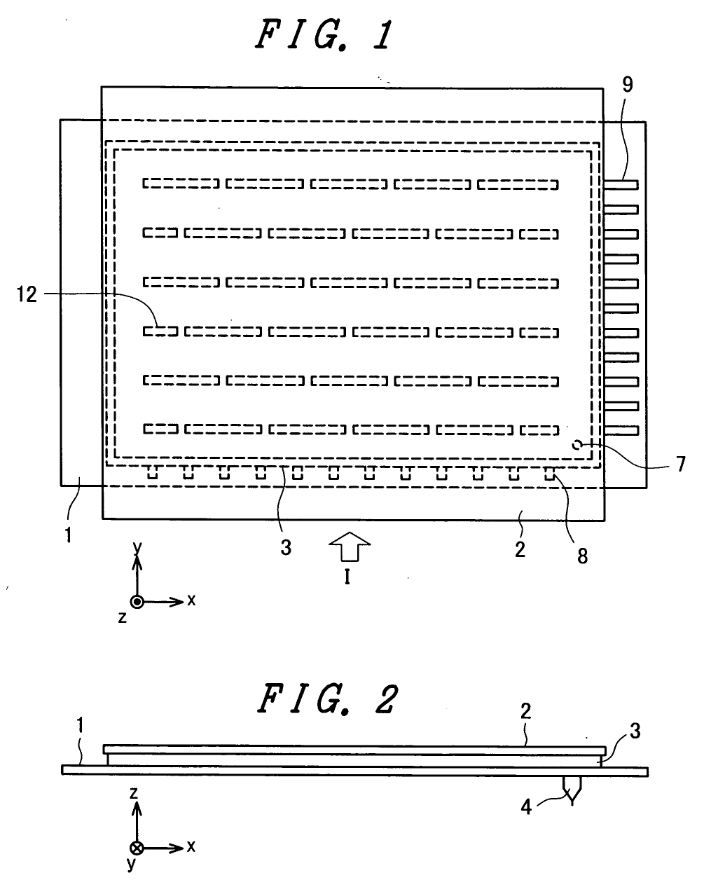

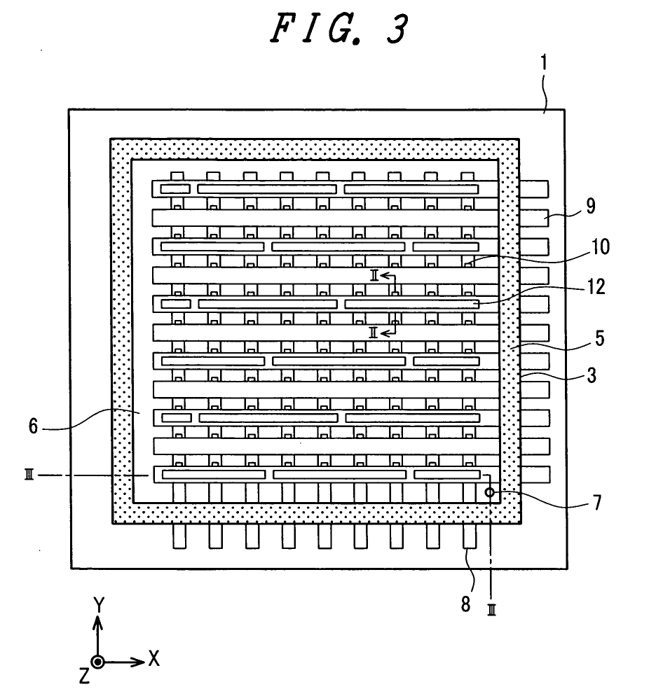

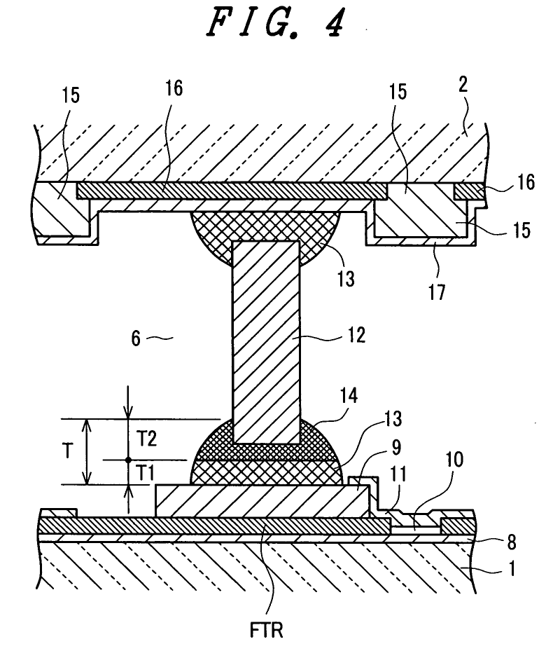

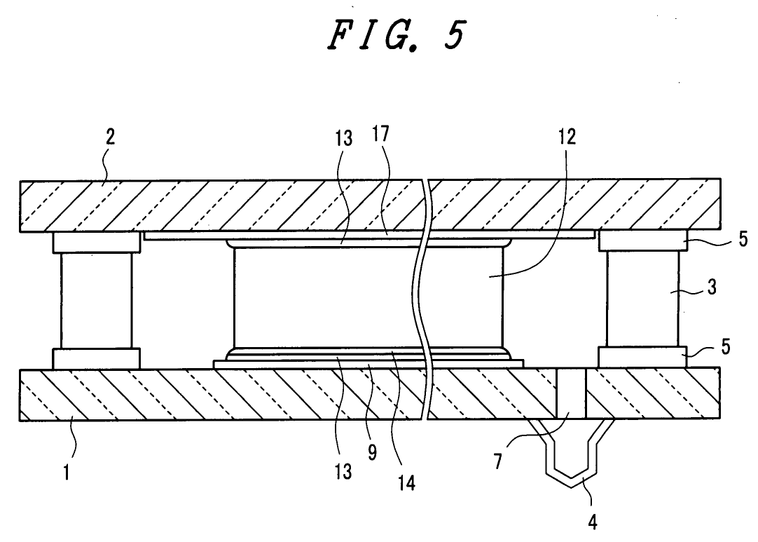

FIG. 1 to FIG. 5 are drawing for explaining an example of a display device of the invention. FIG. 1 is a plan view viewed from the front substrate side; FIG. 2 is a side view viewed from a direction I in FIG. 1; FIG. 3 is a pattern plan view of a back substrate shown with the front substrate in FIG. 1 removed; FIG. 4 illustrates an enlarged pattern cross-sectional view of the back substrate taken along the line II-II in FIG. 3 and an enlarged cross-sectional view of a principal portion of the front substrate corresponding to the back surface; and FIG. 5 is an enlarged cross-sectional view of a principal portion taken along the line III-III in FIG. 3.

In FIG. 1 to FIG. 5, reference numeral 1 designates a back substrate and reference numeral 2 designates a front substrate. The back substrate 1 and the front substrate 2 are formed of glass plates having a thickness of several millimeters, for example, on the order of 3 mm. Reference numeral 3 designates a frame (frame), and the frame 3 is formed of glass plate or a sintered body of frit glass having a thickness of several millimeters, for example, on the order of 3 mm. Reference numeral 4 designates an exhaust pipe, and the exhaust pipe 4 is secured to the back substrate 1. The frame 3 is interposed between the back substrate 1 and the front substrate 2 around the peripheral edge and the back substrate 1 and the front substrate 2 are hermetically sealed via a sealing member 5 formed of frit glass.

Air is discharged from a space surrounded by the frame 3, the back substrate 1, the front substrate 2 and the sealing member 5 by the exhaust pipe 4, and the space is kept to a degree of vacuum of 10⁻³ to 10⁻⁵ Pa, for example. The exhaust pipe 4 is mounted to the outer surface of the back substrate 1 as described above and is in communication with a through hole 7 formed through the back substrate 1. The exhaust pipe 4 after completion of air discharge is sealed. Reference numeral 8 designates an image signal line. The image signal lines 8 extend in Y-direction on the inner surface of the back substrate 1 and arranged in parallel in X-direction.

Reference numeral 9 designates a scanning signal line. The scanning signal lines 9 extend in the X-direction which intersects with the image signal lines 8 and arranged in parallel in the Y-direction. The scanning signal lines 9 are formed on the side of a fluorescent surface with respect to the image signal lines 8. Reference numeral 10 designates an electron source. The electron sources 10 are provided at intersections between the scanning signal lines 9 and the image signal lines 8, and the scanning signal lines 9 and the electron sources 10 are connected by connecting electrodes 11. An inter-layer insulating film FTR is arranged between the image signal lines 8 and the electron sources 10 and the scanning signal lines 9.

The image signal lines 8 are formed of, for example, Al/Nd film and the scanning signal lines 9 are formed of, for example, Ir/Pt/Au film or the like.

Reference numeral 12 designates a spacer. The spacer 12 is formed of ceramics material and is shaped into a rectangular thin plate shape. In this example, the spacers 12 are arranged in an upright posture on every two scanning signal lines 9, and fix the back substrate 1 and the front substrate 2 by an adhesive agent of two-layer structure including a bonding member 13 and a conductive bonding member 14. The spacer 12 is installed normally for every plurality of pixels at a position where the operation of the pixels is not hindered.

The dimensions of the spacer 12 are set according to the dimensions of the substrate, the height of the frame 3, the material of the substrate, the intervals of the spacers, the material of the spacers, and so on. In general, practical values are: substantially the same as the frame 3 described above in height, several tens μm to several millimeter at the maximum in thickness, and on the order of 20 mm to 400 mm in length, more preferably, on the order of 80 mm to 250 mm. The spacer 12 has a value of resistance on the order of 10⁸ to 10⁹ Ω·cm.

The bonding member 13 includes a low-melting point frit glass as a main component (for example, mixed by about 30 wt % to 80 wt %) which exhibits an insulating property and the conductive component (for example, silver fine particles) of several μm to several tens μm (for example, on the order of 3 μm to 10 μm) in diameter which exhibits the conductivity.

The conductive bonding member 14 to be fixedly bonded to the lower end surface of the spacer member 12 includes the conductive component (for example, silver fine particles of about 30 wt % to 80 wt % are contained) of several μm to several tens μm (for example, on the order of 3 μm to 10 μm) in diameter which exhibits the conductivity, and a vitrifiable component formed of low-melting point frit glass, and fixedly bonds the lower end surface of the spacer member 12 to the bonding member 13 on the side of the back substrate 1.

In other words, the bonding member 13 in the lower layer (the back substrate 1 side) is formed in a frit-rich state, and the conductive bonding member 14 in the upper layer (the spacer 12 side) is formed in a metal-rich state. It is a combination which makes the value of resistance of the conductive bonding member 14 lower than that of the bonding member 13. Therefore, reliability of the bonding fixation and the electrical connection of the spacers with respect to the front substrate and the back substrate is secured. The low-melting point frit glass has a composition mainly including, for example, SiO₂, B₂O₃ and PbO.

The bonding member 13 is set to have a thickness Ti of at least several tens μm, preferably, on the order of 20 to 40 μm from the viewpoint of securement of bonding fixation although it depends on the ratio of composition thereof. The conductive bonding member 14 is set to have a thickness T2 of at least several tens pin, preferably, on the order of 20 to 40 μm from the viewpoint of securement of its conductivity although it also depends on the ratio of composition thereof. A total thickness T(T1+T2) is preferably on the order of 50±30 μm, and a large tolerance can be secured for the height of the spacer 12.

The conductive bonding member 14 is provided over the entire length and the entire surface of the proximal portion of the spacer 12 as shown in FIG. 5. The conductive bonding member 14 is opposed to the scanning signal lines 9 so that a discharging circuit can be formed easily from the front substrate 2 on the high-voltage side toward the back substrate 1 on the low-voltage side. The conductive bonding member 14 is preferably applied as an upper layer on the bonding member 13 after having applied and formed the bonding member 13 as the lower layer, and cured simultaneously. It is because silver in the bonding member 13 on the lower layer and silver in the conductive bonding member 14 on the upper layer can easily be integrated, and hence is firmly joined to each other.

The diameter of the silver particle to be contained in the bonding member 13 and the conductive bonding member 14 and the content thereof can be set easily by determining according to the magnitude of the contact resistance with respect to the spacer 12. When the conductive bonding member 14 is formed of a metal film as a single member, it may be fallen due to separation easily. However, since the bonding member 13 which exists on the base contains a large amount of frit glass, separation can be avoided.

The conductive bonding member 14 is formed, for example, by means of printing or the like, and has a value of resistance on the order of 1 to 100 Ω. The material is preferably silver particles from its easiness of handling and low cost. In addition, however, a selected one of materials from a group including, for example, gold (Au), nickel (Ni), copper (Cu), platinum (Pt), palladium (Pd) or alloy particles which contains these materials as a main component can also be used. The bonding frit glass is preferably low-melting point solder glass because the amount of gas discharge is smaller than other bonding materials, and the temperature control is easy. Materials which react with silver and form compound such as a vanadium contained glass may also be used depending on the blending composition.

According to the configuration of Example 1, since the discharging circuit can be formed from the higher voltage side to the lower voltage side by the conductive bonding member 14 provided on the lower voltage side of the spacer 12, the electrostatic charge of the spacer 12 can be eliminated to secure the trajectory of electrons, and hence sufficient number of electrons can be brought into collision for exciting the fluorescent body layer 15. Consequently, a display device with improved luminance and superior in color reproducibility is achieved.

The scanning signal lines 9 may be utilized as the electrodes on the lower voltage side, and the electrodes for preventing the electrostatic charge of the spacer may be formed. According to the configuration of Example 1, the contact between the spacers and the conductive bonding members 14, the contact between the conductive bonding members 14 and the bonding members 13, and the contact between the bonding members 13 and the electrodes on the lower voltage side are reliably achieved, respectively. Since the bonding member also has conductivity, the electrostatic charge of the spacer can reliably be prevented.

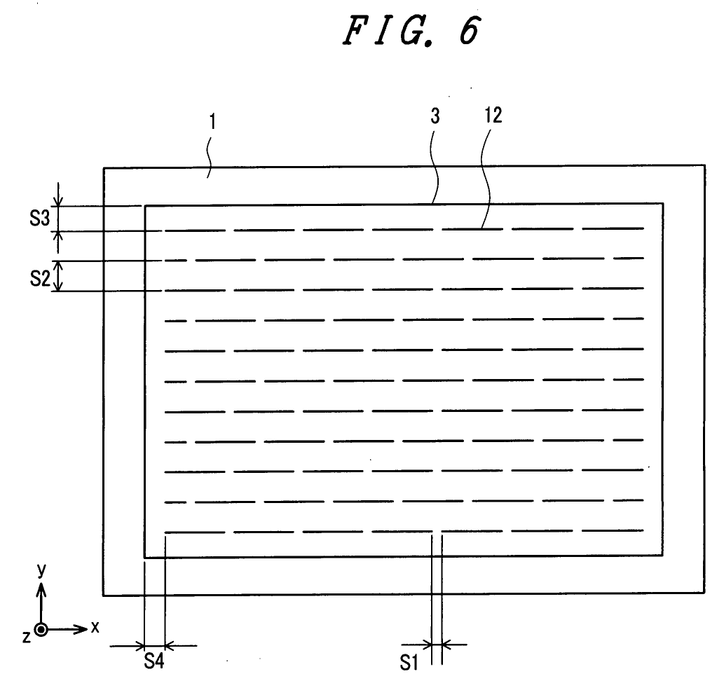

FIG. 6 is a plan view showing an example of the spacer arrangement pattern of the display device according to the invention. The same parts as those in the aforementioned drawings are represented by the same reference numerals and the description will be omitted. The electron emission element or the like are omitted in the drawing. In FIG. 6, a plurality of the spacers 12 are arranged at intervals S1 of about 3 to 50 mm, preferably, about 3 to 20 mm with the longitudinal direction thereof matched with one direction (x-direction), and the plurality of the spacers arranged at regular distances S1 are arranged in parallel to the other direction (y-direction) which intersects with the one direction alternately at distances S2, which is about 3 to 50 mm, preferably about 10 mm to 40 mm.

The distance S3 of the spacers 12 in the direction of arrangement from the long side of the frame 3 is about 3 mm to 50 mm, and more preferably, is about 10 mm to 50 mm. The distance S4 of the spacers 12 from the short side of the frame 3 is about 3 mm to 50 mm, and more preferably, is about 10 mm to 50 mm.

With this number and the position of arrangement of the spacers 12, a stress from the ambient pressure is applied substantially uniformly to the arranged spacers 12, and the spacers 12 are dispersed so as to prevent deflection and damage of the substrate and compression buckling of the spacers 12, the upper and lower end surfaces of the respective spacers 12 are secured to the back substrate 1 and the front substrate 2 via the bonding members 13, and the distance between the back substrate 1 and the front substrate 2 is maintained at a predetermined distance in cooperation with the frame 3.

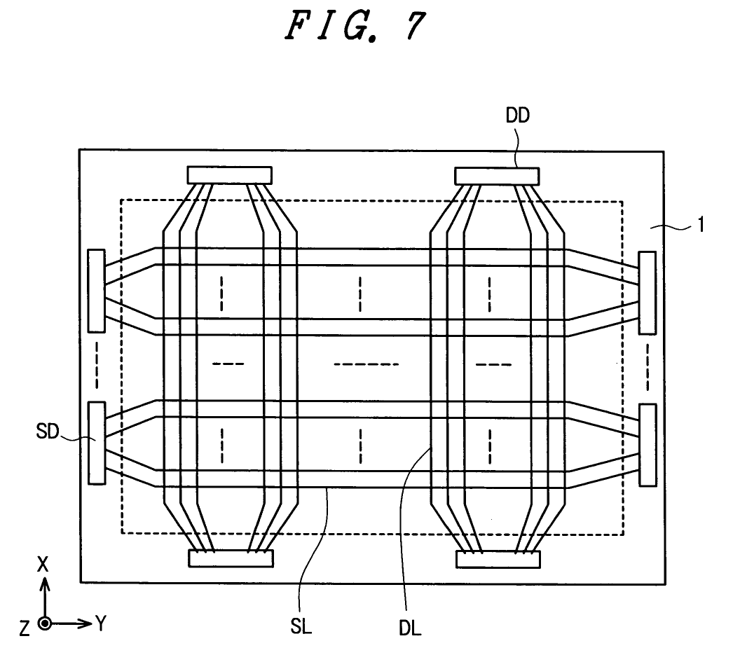

FIG. 7 is a plan view of a principal portion of the back substrate which constitutes the display device according to the invention when viewed from the inner surface side thereof. In FIG. 7, on a main-surface (front surface) of the back substrate 1 which is preferably formed of glass or ceramics material includes a plurality of data lines (also referred to as cathode lines) DL extending in the first direction (y-direction) and being arranged in parallel with the second direction (x-direction) which intersects with the first direction and a plurality of scanning lines SL extending in the second direction (x-direction) and being arranged in parallel with the first direction (y-direction) which intersects with the second direction. The electron emitting elements are formed at intersections or the positions in the vicinity of the intersections of the data lines DL and the scanning lines SL.

The scanning line LS is connected at one end thereof to a scan driver SD. On the other hand, the data line DL is connected at one end thereof to a data driver DD. The front substrate is arranged so as to oppose thereto along a broken line in the drawing. The front substrate 2 and the back substrate 1 are bonded along the outer periphery of the opposed area, and is sealed after having discharged internal gas. The aforementioned spacers are arranged on the scanning lines SL.

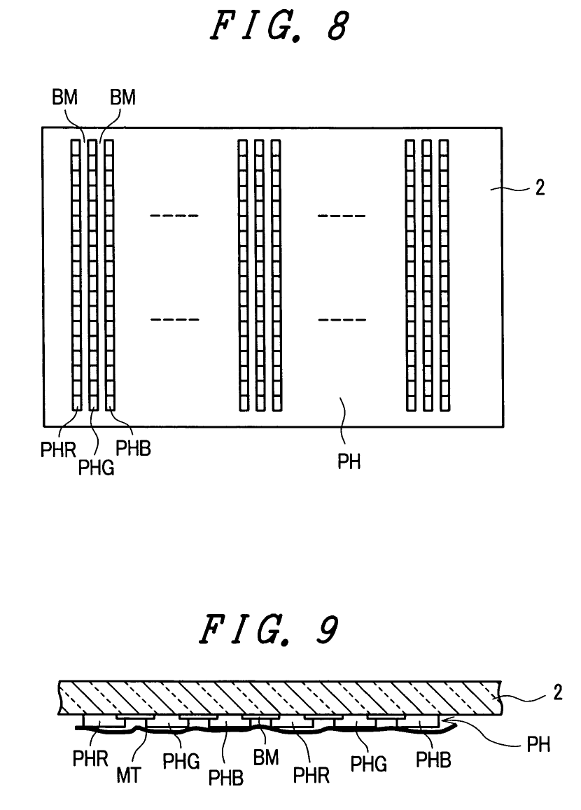

FIG. 8 is a plan view of a principal portion of the front substrate which constitutes the display device according to the invention when viewed from the inner surface side thereof. In FIG. 8, a fluorescent surface PH having red fluorescent material layers PHR, green fluorescent material layer PHG and blue fluorescent material layer PHB is formed on the inner surface of the front substrate 2 formed of light-transmitting glass material along the longitudinal direction of the plurality of data lines DL shown in FIG. 7. In addition, black matrix films BM for partitioning the red fluorescent material layers PHR, the green fluorescent material layers PHG and the blue fluorescent material layers PHB are formed on the fluorescent surface PH.

FIG. 9 is an enlarged cross sectional view of the fluorescent surface PH formed on the inner surface of the front substrate 2. In FIG. 9, the red fluorescent material layers PHR, the green fluorescent material layers PHG and the blue fluorescent material layers PHB which constitute the fluorescent surface PH are formed so as to cover part of the black matrix films BM. A metal back film MT for causing emitted light from the respective red light fluorescent material layers PHR, the green fluorescent material layers PHG and blue fluorescent material layers PHB to be reflected efficiently is formed on the fluorescent surface PH. An anode voltage is applied to the metal back film MT and functions as an anode electrode. The spacers described above are arranged on the black matrix films BM.

In the example shown above, the invention applied to the display device employing the front substrate having the fluorescent material layers and the black matrix films formed on the inner surface thereof and the metal back film (anode electrode) on the back surfaces of the fluorescent material layers and the black matrix films has been described. However, the invention is not limited thereto.

What is claimed is:

1. A display device comprising:
a front substrate having a fluorescent material layer and an anode electrode on the surface thereof;
a back substrate having electron sources on the surface thereof and arranged so as to oppose the front substrate at a predetermined distance;
a frame interposed between the front substrate and the back substrate so as to extend along a display area for keeping the predetermined distance; and
a plurality of spacers arranged in the display area between the front substrate and the back substrate;
the frame, the front substrate and the back substrate being hermetically connected to each other via a sealing member,
wherein the spacers are fixed to the front substrate or the back substrate with bonding members and conductive bonding members which are lower in value of resistance than the bonding member.

2. The display device according to claim 1,
wherein the back substrate comprises:
a plurality of scanning signal lines extending in one direction and arranged in parallel to the other direction orthogonal to the one direction for being applied with scanning signals in sequence in the other direction;
a plurality of image signal lines extending in the other direction and arranged in parallel to the one direction so as to intersect with the scanning signal lines;
the electron sources connected to the scanning signal lines and the image signal lines; and
power supply electrodes for connecting the electron sources to the scanning signal lines and the image signal lines respectively, and
wherein the spacers are arranged and extended so as to be superimposed on the scanning signal lines in the same direction as the scanning signal lines.

3. The display device according to claim 1, wherein the spacers are covered with the conductive bonding members over the proximal end surfaces on the side of the back substrate.

4. The display device according to claim 1, wherein the bonding member includes a vitrifiable component by a ratio of at least 30 wt %, and the conductive bonding member includes a conductive component by a ratio of at least 30 wt %.

5. The display device according to claim 4, wherein the conductive bonding member includes metal particles as the conductive component.

6. The display device according to claim 5, wherein the conductive component of the conductive bonding member includes selected one of materials from a group including gold, silver, nickel, copper, platinum, or palladium or an alloy which contains these materials as a main component.

7. The display device according to claim 1, wherein the spacers have a value of resistance of 10⁸ to 10⁹ Ω·cm.

8. The display device according to claim 1, wherein the spacer member is formed of ceramics material and has an entire length of 400 mm at the maximum.

9. The display device according to claim 1, wherein the conductive bonding member contains frit glass.

10. A display device comprising:
a front substrate having a fluorescent material layer and an anode electrode on the surface thereof;
a back substrate having electron sources on the surface thereof and arranged so as to oppose the front substrate at a predetermined distance;
a frame interposed between the front substrate and the back substrate so as to extend along a display area for keeping the predetermined distance; and
a plurality of spacers arranged in the display area between the front substrate and the back substrate;
the frame, the front substrate and the back substrate being hermetically connected to each other via a sealing member,
wherein the spacers are fixed to the front substrate or the back substrate with bonding members and conductive bonding members which are lower in value of resistance than the bonding member, and the bonding members are arranged on the side of the substrate with respect to the conductive bonding members.

11. The display device according to claim 10, wherein the back substrate comprises:
a plurality of scanning signal lines extending in one direction and arranged in parallel in the other direction orthogonal to the one direction;
a plurality of image signal lines extending in the other direction and arranged in parallel with the one direction; and
the electron sources connected to the scanning signal lines and image signal lines,
wherein the bonding members are arranged on the scanning signal lines and the conductive bonding members are arranged on the bonding members.

12. The display device according to claim 10, wherein the bonding member and the conductive bonding member include a conductive component, and the conductive bonding member contained larger amount of the conductive components than the bonding member.
